(19) United States
(12) Patent Application Publication
(10) Pub. No.: US 2008/0070012 A1
(43) Pub. Date: Mar. 20, 2008

(54) Carrier board and method for manufacturing the same

(75) Inventors: Li-Wei Kuo, Bade City (TW); Ting-Hao Lin, Bade City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: KAYLU INDUSTRIAL CORPORATION, Bade City (TW)

(21) Appl. No.: 11/523,840

(22) Filed: Sep. 20, 2006

(51) Int. Cl. B32B 3/00

(52) U.S. Cl. 428/209

(57) ABSTRACT

A carrier board has a copper substrate, an insulating layer, a copper layer, multiple recesses and a metal circuit layer. The substrate has at least one through hole. The insulating layer is a layer of glue that is insulating, acid-resisting and high-temperature-resisting and is mounted in the at least one through hole and mounted on the substrate. The copper layer is mounted on the insulating layer. The recesses are formed in the copper layer and the insulating layer that is mounted on the substrate. The metal circuit layer is plated on copper layer and along the recesses to contact with the substrate. A heat from the metal circuit layer will transmit to the insulating layer by the copper layer and to the copper substrate. Thus, the carrier board has a heat-dissipating effect without combining with a dissipating apparatus, so LEDs packaged with the carrier board have a small dimension and are compact.

### BACKGROUND OF THE INVENTION

1. Field of Invention

The present invention relates to a carrier board and a manufacturing method thereof, and more particularly to a carrier board that can dissipate heat and to a method to manufacture the carrier board.

2. Description of the Related Art

As technology progressing, an electrical appliance has a reducing dimension and becomes sophisticated. Thus, a light emitting diode (LED) is a good light-emitting element used in the electrical appliance because the LED has many advantages such as a small dimension, high brightness, less power consumption and the LED produces less heat when the LED is used, as compared with conventional light bulbs. The LED has a baseboard with circuit and package materials used in an LED package process.

However, when the appliance with LED operates with other appliances, other appliances will produce heat and transfer heat to LED. Moreover, the LED can not stand for high temperature because conventional package materials generally are plastic, so the package materials will be damaged when the LED has a high temperature and the high temperature will even damage the baseboard and destroy the LED.

For example, conventional package materials include a bismaleimide triazine resin (BT) carrier board to carry an electrical circuit. The BT carrier board does not have any structure for dissipating heat from the circuit, so the BT carrier board has to combine with a heat-dissipating apparatus. Because a conventional heat-dissipating apparatus always has a large dimension, the LED will lose the advantage of a small dimension.

To overcome the shortcomings, the present invention provides a carrier board and a method for manufacturing the carrier board to mitigate or obviate the aforementioned.

### SUMMARY OF THE INVENTION

The primary objectives of the present invention are to provide a carrier board that can dissipate heat and a method for manufacturing the carrier board.

To achieve the objective, a carrier board has a copper substrate, an insulating layer, a copper layer, multiple recesses and a metal circuit layer. The substrate has at least one through hole. The insulating layer is a layer of glue that is insulating, acid-resisting and high-temperature-resisting and is mounted in the at least one through hole and mounted on the substrate. The copper layer is mounted on the insulating layer. The recesses are formed in the copper layer and the insulating layer that is mounted on the substrate. The metal circuit layer is plated on copper layer and along the recesses to contact with the substrate. A heat from the metal circuit layer will be transmitted to the insulating layer by the copper (Cu) layer and to the Cu substrate. Thus, the carrier board has a heat-dissipating capability without combining with a dissipating apparatus, so LEDs have a small dimension and are compact.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view of a carrier board in accordance with the present invention; and

FIG. 2a to FIG. 2n are a series of cross sectional views of the semi-finished products and finished product of the carrier board respectively illustrating the steps of a method for manufacturing the carrier board in FIG. 1.

### DETAILED DESCRIPTION OF THE INVENTION

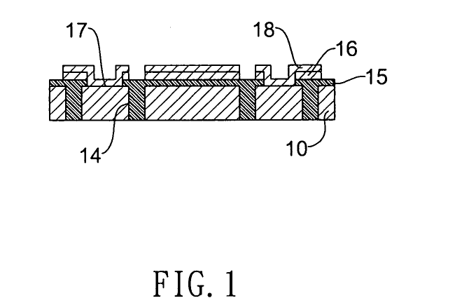

With reference to FIG. 1, a carrier board in accordance with the present invention has a copper substrate (10), an insulating layer (15), a copper layer (16), multiple recesses (17) and a metal circuit layer (18). The substrate (10) has at least one through hole (14). The insulating layer (15) is a layer of glue that is insulating, acid-resisting and high-temperature-resisting and is mounted in the at least one through hole (14) and is mounted on the substrate (10). The copper layer (16) is mounted on the insulating layer (15). The recesses (17) are formed in the copper layer (16) and the insulating layer (15) that is mounted on the substrate (10). The metal circuit layer (18) is plated on copper layer (16) and in the recesses (17) to contact with the substrate (10).

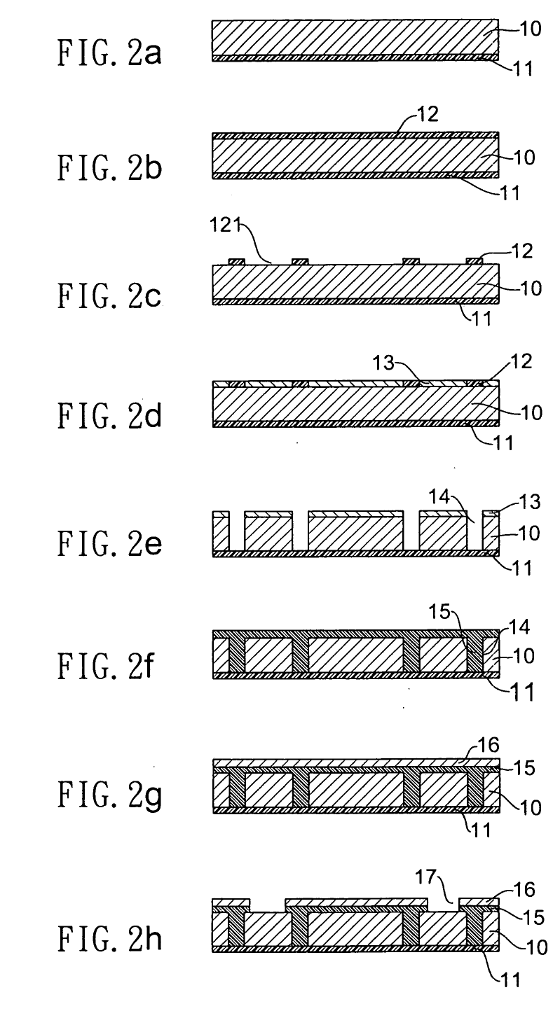

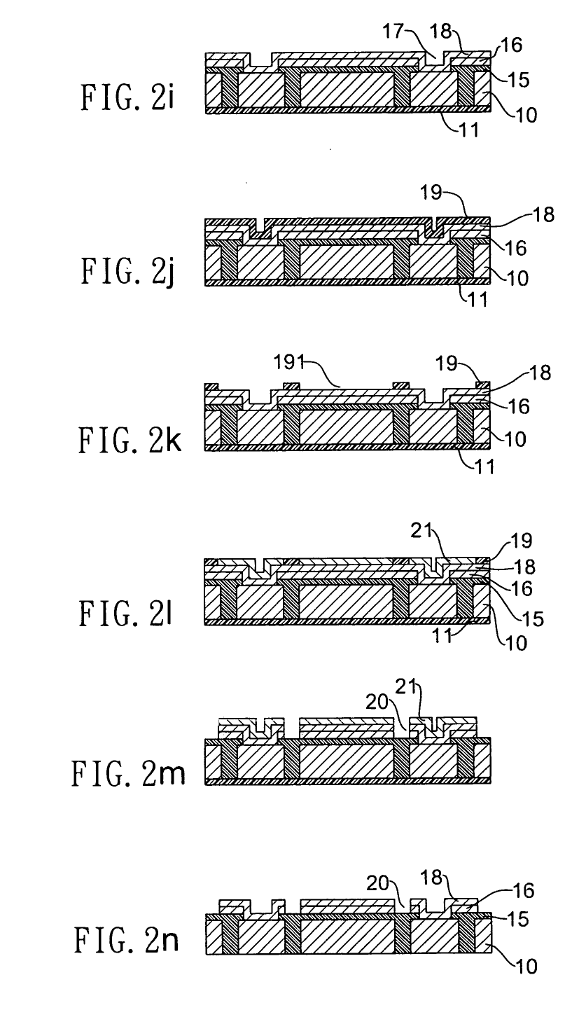

With reference to FIG. 2, a method for manufacturing the carrier board in accordance with the present invention is forming at least one through hole (14) through the substrate (10), mounting an insulating layer (15) of glue in the at least one through hole (14) and on the substrate (10), mounting a copper layer (16) on the insulating layer (15) and mounting the circuit layer (18) on the copper layer (16).

With reference to FIGS. 2a to 2n, detailed steps of the method for manufacturing the carrier board in accordance with the present invention includes a plating step, a first filming step, a first photolithography step, a first protective-layer-plating step, a first etching step, a removing, filling and mounting step, a copper-layer-laminating step, a drilling step, a circuit-layer-plating step, a second filming step, a second photolithography step, a second protective-layer-plating step, a second etching step and a removing step.

With reference to FIG. 2a, the plating step is plating a nickel (Ni) carrier layer (11) on one of two opposite sides of a copper substrate (10) as a carrier to carry the whole copper substrate (10).

With reference to FIG. 2b, the first filming step is filming a hard film (12) on the other side of the copper substrate (10) opposite to the Ni carrier layer (11).

With reference to FIG. 2c, the first photolithography step is transferring a pattern to the hard film (12) to leave at least one portion of the hard film (12) on the substrate (10) and forming at least one notch (121) adjacent to the at least one portion of the hard film (12);

With reference to FIG. 2d, the first protective-layer-plating step is plating a tin (Sn) layer on the substrate (10) and in the at least one notch (121) as a protective layer (13) to protect the substrate (10).With reference to FIG. 2e, the first etching step is etching all of the hard film (12) and at least one portion of the substrate (10) corresponding to and being right under the at least one portion of the hard film (12) to form at least one through hole (14).

With reference to FIG. 2f, the removing, filling and mounting step is removing the Sn protective layer (13) and merely leaving the substrate (10) with the at least one through hole (14), then filling an insulating and heat conductive glue in the at least one through hole(14) and mounting the glue on one side of the substrate (10) to form an insulating layer (15) of the glue opposite to the Ni carrier board layer (11).

With reference to FIG. 2g, the copper-layer-laminating step is laminating a copper (Cu) layer (16) on the insulating layer (15);

With reference to FIG. 2h, the drilling step is drilling multiple recesses (17) through the Cu layer (16) and the insulating layer (15) on the substrate (10) by a laser-drilling method.

With reference to FIG. 2i, the circuit-layer-plating step is plating a metal circuit layer (18) on the Cu layer (16) and in the recesses (17), wherein the metal circuit layer (18) may be made of copper.

With reference to FIG. 2j, the second filming step is filming a hard film (19)on the metal circuit layer (18).

With reference to FIG. 2k, the second photolithography step is transferring a pattern to the hard film (19) on the metal circuit layer (18) to leave at least one portion of the hard film (19) on the metal circuit layer (18) and form at least one detent (191) adjacent to the at least one portion of the hard film (19).

With reference to FIG. 2l, the second protective-layer-plating step is plating a Sn layer on the metal circuit layer (18) and in the at least one notch (191) as a protective layer (21) to protect the metal circuit layer (18).

With reference to FIG. 2m, the second etching step is etching all of the hard film (19) and at least one portion of the metal circuit layer (18) and copper layer (16) corresponding to and being right under the at least one portion of the hard film (19) to form at least one circuit notch (20).

With reference to FIG. 2n, the removing step is removing the Sn protective layer (21) and the Ni carrier layer (11) to obtain the carrier board.

The carrier board producing by the method above has the heat conductive insulating glue mounted on and filled in the Cu substrate (10), the Cu layer (16) mounted between the insulating layer (15) and the metal circuit layer (18). A heat from the metal circuit layer (18) will transmit to the insulating layer (15) by the Cu layer (16) and to the Cu substrate (10). Thus, the carrier board has a heat-dissipating effect without combining with a heat-dissipating apparatus, so a light emitting diode (LED) packaged with the carrier board has a small dimension and is compact.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A carrier board comprising
a copper substrate having at least one through hole;
an insulating layer being a layer of glue that is insulating, acid-resisting and high-temperature-resisting, mounted in the at least one through hole and on the substrate;
a copper layer mounted on the insulating layer;
multiple recesses formed in the copper layer and the insulating layer that is mounted on the substrate; and
a metal circuit layer plated on copper layer and in the recesses to contact with the substrate.

2. The carrier board as claimed in claim 1, wherein the metal circuit layer is made of copper.

3. A method for manufacturing a carrier board comprising steps of forming at least one through hole through a substrate, then mounting an insulating layer of glue in the at least one through hole and on the substrate, mounting a copper layer on the insulating layer and finally mounting the circuit layer on the copper layer.

4. A method for manufacturing a carrier board comprising:
plating a nickel (Ni) carrier layer on one of two opposite sides of a copper (Cu) substrate layer;
filming a hard film on the other side of the copper substrate opposite to the Ni carrier layer;
transferring a pattern to the hard film to leave at least one portion of the hard film on the copper substrate and forming at least one notch adjacent to the at least one portion of the hard film;
plating a tin (Sn) layer on the substrate and in the at least one notch as a protective layer to protect the substrate;
etching all of the hard film and at least one portion of the substrate corresponding to the at least one portion of the hard film to form at least one through hole;
removing the protective layer and merely leaving the substrate with the at least one through hole, then filling the insulating and heat conductive glue in the at least one through hole and mounting the insulating and heat conductive glue on the substrate to form a insulating layer opposite to the Ni carrier board layer;
laminating a Cu layer on the insulating layer;
forming multiple recesses through the Cu layer and the insulating layer on the substrate by a laser drilling method;
plating a metal circuit layer on the Cu layer and in the recesses;
mounting a hard film on the metal circuit layer;
transferring a pattern to the hard film on the metal circuit layer to leave at least one portion of the hard film on the metal circuit layer and form at least one notch adjacent to the at least one portion of the hard film;
plating a Sn layer on the metal circuit layer and in the at least one notch as a protective layer to protect the metal circuit layer;
etching all of the hard film and at least one portion of the metal circuit layer and copper layer corresponding to the at least one portion of the hard film to form multiple circuit notch; and
removing the Sn protective layer and the Ni carrier layer to obtain the carrier board.

5. The method as claimed in claim 4, wherein the metal circuit layer is made of copper.
